(19) United States
(12) Patent Application Publication
(10) Pub. No.: US 2010/0070578 A1
(43) Pub. Date: Mar. 18, 2010

(54) PERSONALIZED MESSAGE TRANSMISSION SYSTEM AND RELATED PROCESS

(76) Inventors: Michael Singer, Woodland Hills, CA (US); Lenny M. Targon, Venice, CA (US)

Correspondence Address: KOPPEL, PATRICK, HEYBL & DAWSON, 2815 Townsgate Road, SUITE 215, Westlake Village, CA, 91361-5827, US

(21) Appl. No.: 12/559,337

(22) Filed: Sep. 14, 2009

Related U.S. Application Data
(60) Provisional application No. 61/096,349, filed on Sep. 12, 2008.

(51) Int. Cl. G06F 15/16; H04W 4/12; G10L 13/00; H04N 7/14

(52) U.S. Cl. 709/204; 455/466; 704/258; 348/14.02

(57) ABSTRACT

The present invention provides systems and methods for transmitting personal messages to less traditional recipients. Some embodiments provide personalized message transmission systems with a user, a non-traditional recipient, a transmitter, and a server. The server is configured to receive one or more messages from the user, with the server converting the one or more messages to a transmittable format and sending the converted messages to the transmitter. The transmitter transmits the one or more messages to a non-traditional recipient. In another possible embodiment, the personalized message transmission system further comprises a device platform for receiving a signal from the transmitter, with the device platform re-transmitting the signal to the user as a confirmation message.

This application claims the benefit of provisional application Ser. No. 61/096,349 to Michael Singer, et al., which was filed on 12 Sep. 2008.

### BACKGROUND OF THE INVENTION

1. Field of the Invention

The present invention generally relates to the transmission of messages, and more particularly to the transmission of personalized messages from a user to a server, where the messages are then converted for further transmission to a desired destination.

2. Background

In recent years, the ability to transmit personal messages in a variety of formats has become commonplace. Developments in personal messaging technology have resulted in the widespread transfer of messages via such formats as voice, text, video, picture, email, and various other data messages. Messages are generally sent by a user to a receiver via a communications network using a variety of devices, services, and technologies. Recipients of the personal messages tend to be friends, family members, colleagues, clients, acquaintances, businesses and the like.

For example, and as is well known in the art, a user may draft a text-based message or record a personal video message and send it to a desired recipient. After the user sends the message but before it reaches the desired recipient, it is received by a server configured to receive the message format provided by the user. The message is then converted into a transmittable format, at which point it is sent to the desired recipient. Depending on the type of message and the device used by the recipient to view the message, the message may be converted again so it is compatible for review by the recipient.

While many types of personal messaging systems and methods have been contemplated for more conventional recipients, it is desirable to provide systems and methods for transmitting messages to less traditional recipients and/or destinations such as: the departed, fictional characters, higher powers, the North Pole, and the universe/space. Moreover, it is desirable to provide a system and method for confirming transmission of personal messages with less traditional recipients.

### SUMMARY OF THE INVENTION

The present invention provides systems and methods for transmitting personal messages to less traditional recipients. The systems and methods may also provide a confirmation means indicating the message has been sent and received by a transmission device. One embodiment provides a personalized message transmission system comprising a user, a non-traditional recipient, a transmitter, and a server. The server is configured to receive one or more messages from the user, with the server converting the one or more messages to a transmittable format and sending the converted messages to the transmitter. The transmitter transmits the one or more messages to the non-traditional recipient.

In another embodiment according to the present invention, a personalized message transmission system is provided comprising a user, a non-traditional recipient, a server, a transmitter, and a platform. The server is configured to receive one or more messages from the user, with the server converting the one or more messages to a transmittable format. The transmitter receives and transmits the one or more converted messages to the non-traditional recipient. The platform receives a signal from the transmitter and re-transmits the signal to the user as a confirmation message.

In another embodiment according to the present invention, a method for transmitting a personalized message to a non-traditional recipient is provided. The method comprises providing a user for drafting or otherwise providing one or more personalized messages. Further, a device is provided for the user to enter the one or more messages onto. Additionally, a server is provided for receiving the one or more messages and converting the messages into a transmittable format. A transmitter is provided for receiving the converted messages, with the transmitter transmitting the one or more messages to the recipient.

These and other further features and advantages of the invention would be apparent to those skilled in the art from the following detailed description, taken together with the accompanying drawings, in which:

### BRIEF DESCRIPTION OF THE DRAWINGS

FIG. 1 is a schematic view of one embodiment of a personalized message transmission system according to the present invention;

FIG. 2 is a screen view from a website employing the personalized message transmission system shown in FIG. 1

FIG. 3 is a screen view from another website employing the personalized message transmission system shown in FIG. 1; and

FIG. 4 is a flow diagram depicting operation of the personalized message transmission system shown in FIG. 1;

FIG. 5 is a schematic view of one embodiment of a confirmation system for a personalized message system according to the present invention; and

FIG. 6 is a flow diagram depicting operation of a personalized message transmission system according to the present invention.

### DETAILED DESCRIPTION OF THE INVENTION

The following description presents several possible embodiments of practicing the present invention. This description is not to be taken in a limiting sense but is made merely for the purpose of describing the general principles of the invention, the scope of which is further understood by the appended claims.

The present invention provides systems and methods for transmitting personalized messages to less traditional recipients. The systems and methods may also provide a confirmation means indicating the message has been sent and received by a transmission device. In particular, the present invention provides systems and methods for transmitting messages to non-conventional recipients, which may include such figures as, but not limited to, the following: the departed, higher powers, aliens, astronauts, and Santa Claus and other fanciful persons. The non-conventional recipients may also include such destinations as, but not limited to, the following: space, the universe, the North Pole, and the heavens.

Embodiments of the present invention are generally directed to users sending personalized messages from a computer, but it is understood that other communication devices such as phones, pagers, radios, televisions, and the like may also be used. It is also understood that when an element or feature is referred to as receiving or transmitting information or messages from another element or features, it can be directly receiving or transmitting information/messages from that element or intervening elements may also be present.

According to one embodiment of the present invention, a personalized message transmission system includes a provider having a server configured to receive messages from users, convert the received messages into a transmitter-compatible format and send the converted messages to a transmitter for transmission. Further, according to one possible aspect of the embodiment, the system may include a transmitter adapted to transmit the message into space. According to another possible aspect of the embodiment, the system may include a transmitter adapted to send the message to the North Pole. It is understood that a transmitter may be adapted to send the message to a variety of non-traditional recipients as discussed above.

According to another aspect of the present invention, the server receives a message from the user in the form of an email, which is then transmitted to the desired recipient. According to another aspect of the invention, a text message from the user may be received by the server, which then generates a synthesized speech message to the recipient based on the text message. Alternatively, the text message is sent from the server to the transmitter in its text form. In another aspect of the present invention, a message from the user in the form of an electronic card may be sent to the server, which will then transmit the card, possibly with a generated synthesized speech message, to the desired recipient. While these present some possible aspects and variations of the present invention, it is understood that other message formats may be sent by the user according to the present invention. Moreover, the server may generate various types of formats from the original message to be transmitted to the desired recipient according to the present invention. These and other features, aspects, objects and advantages of the present invention will be better understood in view of the drawings and the following detailed description of possible embodiments.

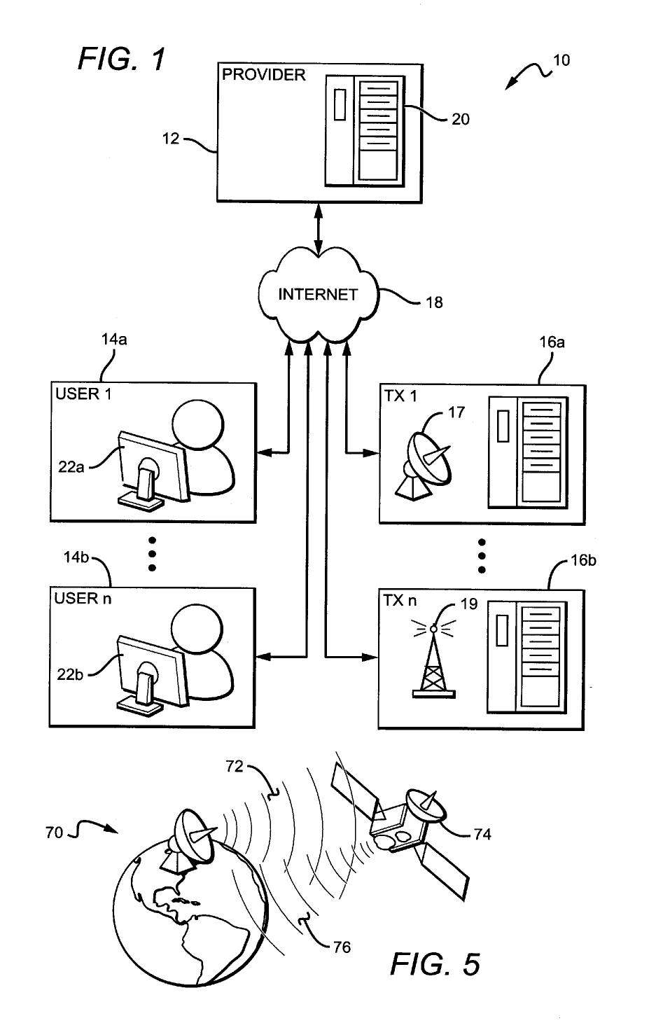

With reference to FIG. 1, a personalized message transmission system 10 may include a provider 12, one or more users 14a, 14b, and one or more transmitters 16a, 16b connected through a network medium 18, such as the Internet. While FIG. 1 depicts one provider, two users, two transmitters, and one network medium, it is understood that fewer or more of each element may be provided in accordance with the present invention. Additionally, other network mediums, including, but not limited to, wide- or local-area networks may also be used to connect the provider 12 with the users 14 and transmitters 16. Also, the provider 12 may be directly connected to the users 14 and/or transmitters 16, eliminating the need for a network medium 18. The transmitters 16a, 16b may be one or more of several different transmitter-categories. For example, the transmitter may comprise a satellite dish 17 or an antenna 19. However, it is understood that various other types of transmitters may also be used.

The provider 12 may comprise an associated server 20, which may be configured to host one or more websites (not shown) for access by the users 14a, 14b. The websites would allow the users 14a, 14b to enter personalized messages on devices such as computers 22a, 22b for transmission to a desired recipient by the transmitters 16a, 16h. While websites are one advantageous means for the users 14a, 14b to access the server 20, it will be appreciated that other known applications offering a user interface may alternatively be employed. Also, while computers are one advantageous device for drafting or otherwise providing messages on, it will be appreciated that other appropriate devices may also be used. Furthermore, the term “server” is not necessarily limited to a web server or network server. Moreover, the provider 12 could operate a plurality of servers 20, with the two or more servers 20 potentially being geographically distant from one another.

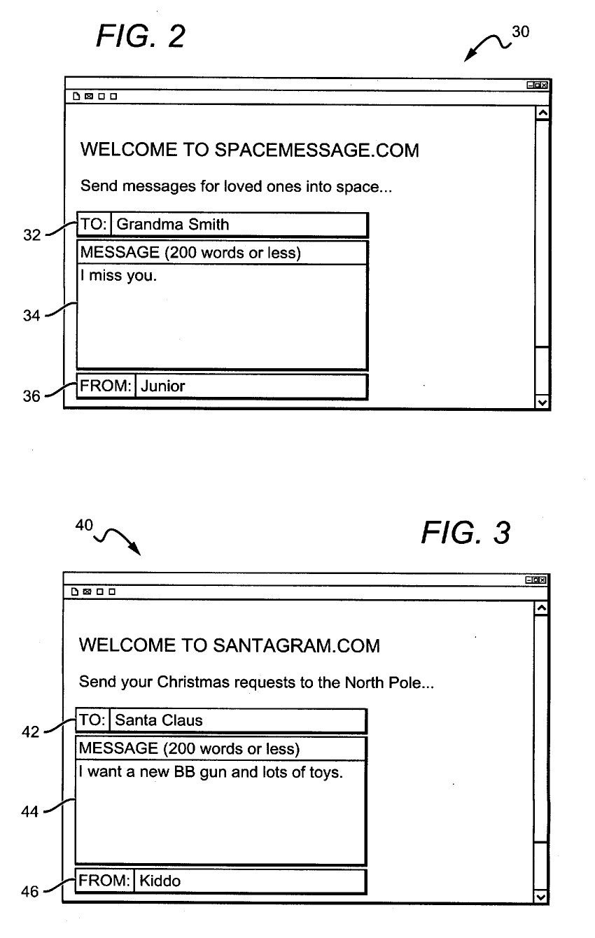

In accordance with one aspect of the present invention, a provider coordinates with a transmitter(s) that is configured to broadcast the users' personalized messages into space or another non-traditional destination as described above. As depicted in FIG. 2, a screenshot 30 is shown of a website hosted by a server. A user is prompted to identify a desired recipient (in this case the departed “Grandma Smith”) into a recipient field 32, enter a message (e.g. “I miss you.”) into a message field 34, and identify a sender (e.g. “Junior”) in a sender field 36. The user will then send the personalized message to the desired recipient using the prompts on the website, which will be sent from the server to a transmitter(s). The transmitter(s) will send a desired format of the personalized message to the desired recipient; in this example the recipient/destination is space.

In accordance with another aspect of the present invention, a provider coordinates with a transmitter(s) that is configured to broadcast the users' personalized messages to be received at the North Pole. As depicted in FIG. 3, a screenshot 40 is shown of another website hosted by a server. A user enters the recipient in box 42, with the recipient here identified as “Santa Claus”. Then, the user is prompted to enter a message into a message field 44, and then identify the sender in a sender field 46. The user will then send the personalized message to the desired recipient using the website, which will be sent from the server to a transmitter(s). The transmitter(s) will send a desired format of the personalized message to the desired recipient.

It is appreciated that one desirable feature of the present invention for users is the comfort of sending their message to their departed loved ones into space (as in FIG. 2), or the entertainment of knowing their gift requests are being transmitted to the North Pole (as in FIG. 3). However, the present invention is not limited to these example aspects. As described above, messages can be transmitted to other desired, non-traditional recipients for a plurality of reasons.

Additionally, messages can be transmitted without a specific location intended. For example, messages can be transmitted such that they are calculated to be received by recipients. In one example, the message(s) can be transmitted over AM or FM radio frequencies in the area of the recipient, with the recipient prompted to tune into a given AM/FM frequency at a particular time. It is understood that the present invention is not limited to a particular transmission format or frequency. For instance, transmissions can be made that are adapted for receipt by radios, televisions, satellite television receivers, shortwave radios, or cellular telephones, among others.

It is also understood that the term “message” is not necessarily limited to a written or spoken communication. For example, a “message” may include, but is not limited to: text, images, audio content, video content, or a combination of one or more of the preceding formats.

In another aspect of the present invention, a server can be configured to accept payment from a user in exchange for the provider coordinating transmission of messages. Additionally, the provider can remit a portion of the payment received from a user to the corresponding transmitter(s) in exchange for use of transmission facilities. Thus, the present invention enables a valuable subsidy to aid in the maintenance of the provider/server and transmission facilities. As such, the present invention may indirectly support research efforts using transmission facilities that may be insufficiently funded.

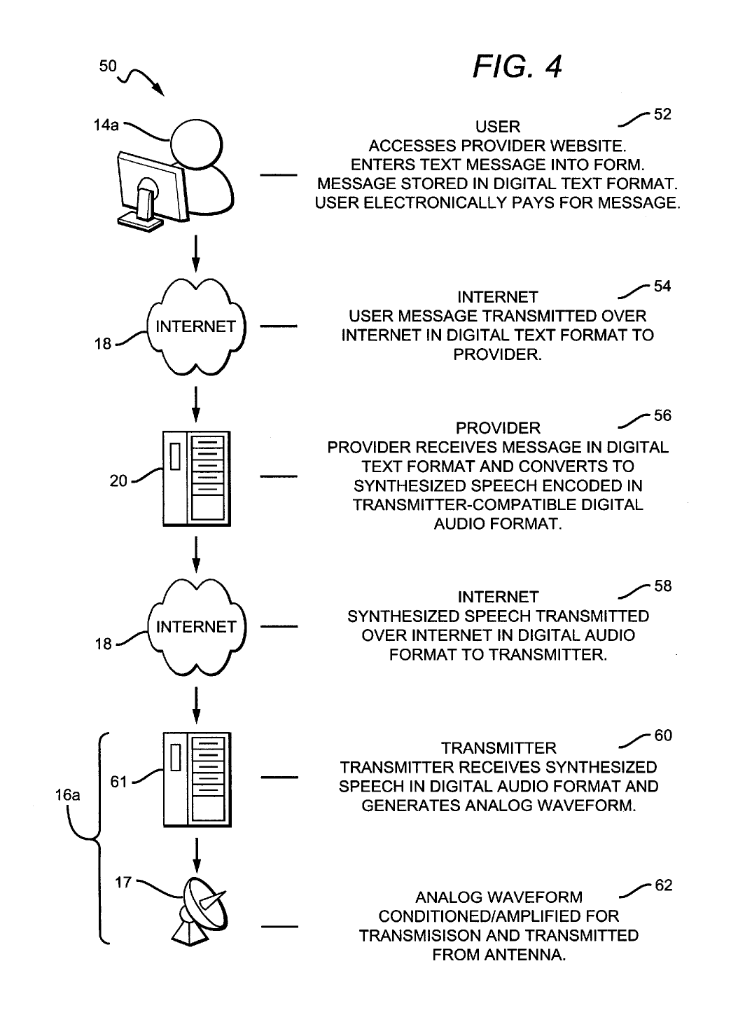

As shown in FIG. 4, one possible process 50 for personalized message transmission according to the present invention is explained in detail. At 52, a user 14a accesses a provider website, hosted by a server 20. The user 14a enters a message into fields provided by the website. The message is stored in a suitable text format, such as a rich-text, digital format. The user 14a may optionally transfer electronic payment to complete a transaction with the server 22.

At 54, the message is transmitted to the server 20 using standard internet transmission or other suitable protocols. A text-based message requires less bandwidth than a digital audio format for a user recorded message, but it understood that either type of message may be transmitted in accordance with the present invention. The received text message could also be forwarded for transmission in its digital text format. However, to enhance the personal nature of the message transmission and the sense of actual communication (even when no actual, conventional recipient is likely), an analog radio transmission may be desirable.

Accordingly, at 56 the server 20 may convert the digital text format message into synthesized speech encoded into a digital audio format that is compatible for receipt at the transmitter. Speech can be synthesized using a variety of speech-production methods well known in the art. For example, concatenative synthesis may be used. Specifically, unit selection concatenative synthesis may be desirably employed, such that the synthesized speech approximates a natural voice. The server 20 can also maintain databases of speech units (such as phrases, words, or diphones) sampled from different individuals, such as famous people. For example, the user 14a may choose to have his/her text message transmitted in the voice of a famous actor or athlete. A sample of the synthesized speech could also be supplied to the user 14a via the website. Additionally, the user 14a can also be given the option to have his/her message translated into another language. This can be accomplished, for example, by automatically translating the text into the selected language and synthesizing speech based on the translated text.

If speech synthesis is to be employed to convert the message, the present invention is not limited to concatenative synthesis. For example, formant or articulatory synthesis may also be employed. To facilitate swift transmission of the message, it is preferable to generate synthesized speech directly into a digital audio format. However, the present invention may also generate an analog audio signal, which can then be digitally sampled.

At 58, the digital audio signal is transmitted to the transmitter 16a, for instance, again using standard internet transmission protocols. At 60, a server 61 at the transmitter receives the digital audio signal with the synthesized speech and converts the signal into an analog audio signal.

At 62, the transmission equipment 16a conditions and amplifies the analog audio signal such that it is ready for transmission from a satellite dish 17 or antenna. For example, the carrier wave generated by the transmitter 16a would be modulated and/or amplified based on the audio signal to generate the final waveform for transmission. The waveform is transmitted from the satellite dish 17 or antenna, completing the personalized message transmission process.

The present invention is not necessarily limited to the above-described embodiment. Rather, those skilled in the art will appreciate that various modifications and adaptations for particular circumstances and customized messaging are possible within the scope of the present invention. For example, in addition to or instead of a typed message, the user 14a could generate a message from a list of provider-generated messages. Additionally, the present invention could also allow uploading of text files, as well as the creation or uploading of image, video and audio files, among others, for subsequent transmission.

Furthermore, the server 20 can provide a spell check feature to identify misspelled or unknown words. For unknown words, the user 14a can be prompted to provide a pronunciation or phonetic spelling of the word to facilitate accurate text to speech conversion.

For transmitters that are not equipped to receive digitally-formatted audio messages and convert them into an analog audio signal for transmission, the server 20 can be configured to convert the text message, either directly or indirectly, into an analog audio signal that is then passed by an appropriate medium to the transmitter.

Additionally, a confirmation scheme 70 for the sent message(s) can be provided such that the user collects a confirmation that the message(s) was received by an appropriate device. For example, as shown in FIG. 5, a signal 72 sent from the transmitter 16a into space can be detected by a satellite 74 or other suitable platform. The satellite 74 can then re-transmit the signal 72 to earth as a confirmation signal 76. The confirmation signal 76 is received on earth, for instance, by receivers associated with the transmitter 16a or other receivers, and forwarded to the sender. Accordingly, the sender has added security and satisfaction knowing the message has been sent and received.

It will be appreciated that detection of the transmitted signal and re-transmission of the signal as a confirmation is not limited to space transmission applications. For instance, in the “Santa Claus” example, receivers situated near the Arctic Circle could detect the transmitted signal and retransmit a confirmation. Additionally, the confirmation can simply be the re-transmitted original message, or the confirmation can include additional and/or different information. For instance, in the “Santa Claus” example, the confirmation can include a “Ho! Ho! Ho!” in addition to the originally transmitted message.

The foregoing is not an exhaustive list of confirmation scheme variations. Rather, those skilled in the art will appreciate that these and other modifications and adaptations are possible and contemplated within the scope of the invention herein.

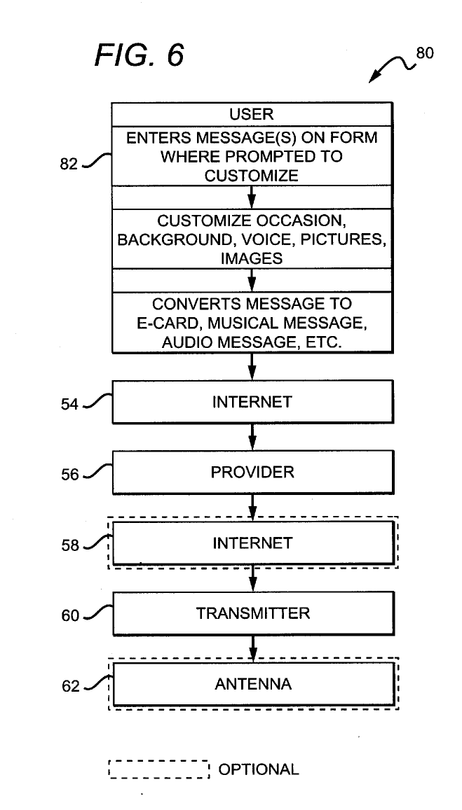

FIG. 6 depicts another possible process 80 for personalized message transmission according to the present invention. In process 80, a message created on the Internet, text SMS, phone or the like is sent to a non-traditional recipient such as space. The steps of process 80 are comparable to steps 54, 56, 58 (optional), 60, 62 (optional) depicted in FIG. 4; however, it is optional whether the message is converted to synthesized speech. The message may be received by the recipient as a text-based message, electronic card, etc. The main differences of process 80 from process 50 occur at the user level. For example, at 82, the user enters his/her message(s) onto a form where he/she is prompted to customize the message in a variety of ways. For example, the user may customize the backgrounds, occasion, voices (e.g. to read the card aloud to the recipient), pictures, images, and so forth to be added to his/her message(s). The message may then be converted into a final format for transmission, which may comprises an electronic card, text-based message, musical message, audio message, or the like. The message is transmitted to the desired non-traditional recipient, and may also be copied back to the user or any additional recipients chosen by the user. Additionally, the message may then be printed or posted at other websites.

Although the present invention has been described in considerable detail with reference to certain preferred configurations thereof, other versions are possible. Accordingly, the spirit and scope of the invention should not be limited to the preferred versions of the invention described above.

We claim:

1. A personalized message transmission system, comprising:
a user;
a non-traditional recipient;
a transmitter; and
a server configured to receive one or more messages from said user, said server converting said one or more messages to a transmittable format and sending said converted messages to said transmitter, with said transmitter transmitting said one or more messages to said non-traditional recipient.

2. The personalized message transmission system of claim 1, wherein said non-traditional recipient may comprise one or more of: a departed loved one, a higher power, an alien, an astronaut, Santa Claus, the heavens, space, the universe, or the North Pole.

3. The personalized message transmission system of claim 1, wherein said user creates said one or more messages on and sends said messages from a communication device.

4. The personalized message transmission system of claim 3, wherein said communication device comprises one or more of the following: a computer, a phone, a pager, a radio, or a television.

5. The personalized message transmission system of claim 3, wherein said communication device sends said one or more messages to a server.

6. The personalized message transmission system of claim 1, further comprising a provider having said server.

7. The personalized message transmission system of claim 1, wherein said one or more messages comprises one or more of the following: an email, a text message, an electronic card, images, audio content, video content, or a combination of these formats.

8. The personalized message transmission system of claim 1, wherein said server converts said one or more messages into a synthesized speech message.

9. The personalized message transmission system of claim 8, wherein said synthesized speech message may be read aloud to said recipient.

10. The personalized message transmission system of claim 8, wherein the speech of said synthesized speech message may be generated using one or more of the following: concatenative synthesis, speech databases comprising speech units, or foreign language translation devices.

11. The personalized message transmission system of claim 1, wherein said server, user, and transmitter are connected by a network medium.

12. The personalized message transmission system of claim 11, wherein said network medium comprises the internet, wide-area networks, or local-area networks.

13. The personalized message transmission system of claim 1, wherein said transmitter comprises an antenna or a satellite dish.

14. The personalized message transmission system of claim 1, wherein said server may be configured to host one or more websites accessible by and providing a user interface for said user.

15. The personalized message transmission system of claim 14, wherein said user may enter said messages onto said one or more websites.

16. The personalized message transmission system of claim 1, wherein said one or more messages are adapted for receipt by one or more of the following: radios, televisions, satellite television receivers, shortwave radios, or cellular telephones.

17. The personalized message transmission system of claim 6, wherein said server can be configured to accept payment from said user in exchange for said provider coordinating transmission of said messages.

18. The personalized message transmission system of claim 1, wherein said transmitter may receive messages in digital or analog format.

19. The personalized message transmission system of claim 1, wherein said server may convert digitally-formatted audio messages into analog audio signal for transmission.

20. The personalized message transmission system of claim 1, further comprising a device platform for receiving a signal from said transmitter, said platform re-transmitting said signal, which is receivable by said user as a confirmation message.

21. A personalized message transmission system, comprising:
a user;
a non-traditional recipient;
a server configured to receive one or more messages from said user, said server converting said one or more messages to a transmittable format;
a transmitter, said transmitter receiving and transmitting said one or more converted messages to said non-traditional recipient; and
a device platform for receiving a signal from said transmitter, said platform re-transmitting said signal to said user as a confirmation message.

22. The personalized message transmission system of claim 21, wherein said non-traditional recipient may comprise one or more of: a departed loved one, a higher power, an alien, an astronaut, Santa Claus, the heavens, space, the universe, or the North Pole.

23. The personalized message transmission system of claim 21, wherein said device platform comprises a satellite.

24. A method for use in transmitting a personalized message to a non-traditional recipient, comprising:
providing a user for drafting or otherwise providing one or more personalized messages;
providing a device for said user to enter said one or more messages onto;
providing a server for receiving said one or more messages and converting said messages into a transmittable format; and
providing a transmitter for receiving said converted messages, with said transmitter transmitting said one or more messages to said recipient.

25. The method of claim 24, further comprising a provider website accessible by said user, said website hosted by said server, wherein said user enters said messages into fields provided by said website.

26. The method of claim 24, said server converting a text-based message into synthesized speech compatible for receipt by said transmitter.

27. The method of claim 24, wherein said user customizes said one or more messages by choosing from a variety of backgrounds, occasions, voices to read the message to said recipient, images, and music.
